(19) United States
(12) Patent Application Publication
(10) Pub. No.: US 2026/0300671 A1
(43) Pub. Date: Oct. 1, 2026

(54) METAL SMART CARD WITH INTEGRATED COMPONENTS FOR REGISTERING SAID SMART CARD ON A MOBILE DEVICE

(71) Applicant: IDEMIA FRANCE, Courbevoie (FR)

(72) Inventors: Agnès DUVAL, Courbevoie (FR); Tiphaine GROULT, Courbevoie (FR); Oumar BARRO, Courbevoie (FR)

(73) Assignee: IDEMIA FRANCE, Courbevoie (FR)

(21) Appl. No.: 19/555,001

(22) Filed: Mar. 3, 2026

(30) Foreign Application Priority Data
Mar. 25, 2025 (FR) FR2503084

(51) Int. Cl. G06K 19/077

(52) U.S. Cl. CPC G06K 19/07722

(57) ABSTRACT

A smart card including a card body and an insert, the card body including a metal layer having a blind cavity open on a first face, the insert being inserted into the cavity and including an electronic module having an external face flush with the first face and including a contact surface disposed on the external face and a microcircuit. The insert also includes a magnetic shielding layer and a radio-frequency antenna electrically connected to the microcircuit and disposed between the contact surface of the electronic module and the magnetic shielding layer.

### TECHNICAL FIELD OF THE INVENTION

The invention relates to a smart card, and more particularly to a metal smart card, that is to say a smart card comprising a card body comprising a metal layer.

The invention also relates to an assembly comprising such a smart card and a mobile device and to use of this assembly.

### PRIOR ART

A smart card is used in many applications, for example as a bank card, a loyalty card or an access card. It can have different formats depending on its use. A smart card is designed to perform a variety of functions, in particular performing banking transactions, authenticating the card holder, or accessing restricted areas or secure services.

A smart card generally comprises a card body in which an electronic module is integrated. The electronic module is configured to perform functions associated with the use of the card. The card body may also contain communication means that allow data interchange with an external terminal.

The smart card, in particular its electronic module, comprises, for example, external contacts, accessible on the surface of the card, for making an electrical connection with contact pins of the external terminal. This mode of communication is called “contact-based”.

Some smart cards are also configured to establish so-called “contactless” communication, allowing them to interchange data with an external terminal without a physical connection.

A metal smart card is a card that comprises at least one metal layer forming the body of the card. The visual effect of the metal, the shiny or brushed reflections and also the weight of the metal lend this type of card the impression of quality and prestige, which is sought after by some users.

In order to limit the components and thus increase the weight and the metallic appearance, it has been proposed to provide a metal smart card which only allows contact-based communications to be established, for example only contact-based payments in the case of a bank card.

In order to allow the user to carry out contactless communications using such a card, one approach consists in registering data representative of the smart card on a smartphone. Once these data have been registered, the smartphone may be used to carry out contactless communications in place of the smart card.

Representative data are registered on the smartphone using an external device initially supplied with the card. In one particularly convenient exemplary embodiment, this device is integrated into the packaging of the smart card. This device comprises a microcircuit and a radio-frequency antenna. The microcircuit registers (stores) a unique code allowing the smartphone to retrieve the representative data. The radio-frequency antenna is electrically connected to the microcircuit and is configured to transmit the unique code in response to interrogation from the smartphone.

During the registration, the user moves their smartphone close to the device. Owing to the radio-frequency antenna, the smartphone reads the unique code registered in the microcircuit and thus registers the data representative of the smart card in a secure manner.

However, after the registration, the device is no longer useful and is generally discarded with the packaging. It then becomes electronic waste which is difficult to recycle, or even non-recyclable, this posing an environmental problem.

There is therefore a need to provide a solution for limiting the electronic waste for registering a metal smart card on a smartphone.

### SUMMARY OF THE INVENTION

The present invention aims to overcome all or some of the drawbacks of the prior art mentioned above, which may lead to other advantages.

To this end, the invention is targeted at, according to a first aspect, a smart card comprising a card body and an insert, the card body comprising a metal layer having a first face, a second face opposite the first face, and a blind cavity open on the first face and defining a periphery on said first face, the insert being inserted into the cavity and comprising
an electronic module having an external face flush with the first face of the metal layer and comprising:
   a contact surface disposed on the external face and configured to allow contact-based communication with an external terminal, the external contact surface having a contour of which a gap with the periphery of the cavity on the first face of the metal layer is less than or equal to 0.5 mm,
   a microcircuit configured to register a unique code associated with data representative of the smart card,
a magnetic shielding layer, and
a radio-frequency antenna electrically connected to the microcircuit and disposed between the contact surface of the electronic module and the magnetic shielding layer.

In the smart card according to the invention, the components necessary for registering the representative data on a mobile device, namely the microcircuit and the radio-frequency antenna, are directly integrated into the metal layer of the card body.

Thus, when a user wishes to register the data representative of the smart card on a mobile device, for example for the purpose of making contactless payments with the mobile device in place of the smart card, they only need to move the smart card close to the mobile device.

The microcircuit and the radio-frequency antenna therefore remain in the smart card after the registration. If the smart card is supplied in packaging made of recyclable material, this packaging can be fully recycled since it does not contain such electronic components.

However, integrating additional components into a metal smart card goes against the practices of designers.

Specifically, a metal smart card is sought after for its heavy weight and its metallic appearance. Any modification that could reduce the mass of metal or alter its appearance is therefore avoided.

The integration of a radio-frequency antenna sized to be able to be used within the scope of EMV transactions, that is to say meeting the communication distance requirements defined by the technical specifications “EMV Level 1 Specifications for Payment Systems-Contactless Interface Specification” and “PayPass-Combination Test”, into the metal layer is all the more avoided by designers since it requires the addition of a magnetic shielding layer to limit magnetic interference. Specifically, this additional layer is likely to further reduce the weight of the metal smart card because of the limited total thickness of the card, since this involves reducing the proportion of metal in the card.

The inventors have overcome these biases by integrating such components (a microcircuit, a radio-frequency antenna and a magnetic shielding layer) in a way which limits, or even avoids, the degradation of the metallic appearance and the reduction in weight.

In other words, the inventors have ensured that, visually and in terms of perception of weight, the smart card according to the invention seems to consist solely of metal, with the exception of the electronic module which remains visible.

On the one hand, the gap between the periphery of the cavity and the contour of the contact surface of the electronic module is chosen so as to conceal the radio-frequency antenna and the magnetic shielding layer behind the contact surface.

The periphery is defined here as the line formed by the intersection between a surface of the first face and internal walls of the cavity. More precisely, the periphery may be defined as the set of points where the tangent to the surface begins to incline with respect to the plane of the first face.

The gap corresponds to the maximum distance measured perpendicularly between the contour of the contact surface of the electronic module and the periphery of the cavity on the first face of the metal layer.

Thus, looking at the first face of the smart card, only the electronic module filling the cavity is visible. The radio-frequency antenna and the shielding layer are not visible, this allowing the aesthetic appearance of the smart card to be preserved.

On the other hand, the cavity formed in the metal layer is blind, that is to say that it does not pass through the entire thickness of the metal layer. This limits the amount of material removed from the metal layer, and allows the smart card to retain a relatively heavy weight.

The cavity also allows the second face to have an entirely metallic surface, this giving a maximum metallic effect to this face.

The cavity may, however, prevent the smart card from establishing contactless communication from each of its faces because the metal constitutes an obstacle to radio-frequency transmissions.

Nevertheless, this does not pose any problems of use because the smart card according to the invention does not need to establish contactless communications (in particular payments) itself. As explained above, this function can be ensured by a mobile device on which data representative of the card are registered.

Consequently, the smart card according to the invention makes it possible to limit electronic waste after said smart card has been registered on a mobile device, all while limiting the degradation of the metallic appearance and the reduction in weight.

Preferred, simple, convenient and economical features of the smart card according to the invention are presented below.

The microcircuit can be electrically connected to the external contacts to allow contact-based communication between the microcircuit and an external terminal.

The smart card thus takes advantage of the microcircuit already present, configured mainly to allow contact-based communication, to register the smart card on a mobile device. Using an already present component to perform the function of registering the card on a mobile device avoids adding a new component. This thus allows the card to retain a relatively great weight and metallic appearance.

The volume of the insert may represent at least 75% of the volume of the cavity, that is to say between 75% and 100% of the volume of the cavity.

For example, the volume of the insert may represent at least 80%, 85%, 90%, 95%, or even 100% of the volume of the cavity.

The fact that the majority of the volume of the cavity is occupied, combined with the weight of the components, at least partially compensates for the removal of metal in terms of weight. The weight of the card is thus kept relatively heavy.

The insert may have a length and a width which are defined by the contour of the contact surface of the electronic module, the length and the width corresponding to the length and to the width of the insert in a plane parallel to the external face of the electronic module.

In other words, the insert does not protrude laterally beyond the periphery defined by the contact surface of the electronic module.

However, this design for the insert means that the radio-frequency antenna has dimensions smaller than or equal to those of the contact surface.

A radio-frequency antenna of this size cannot allow contactless communication in accordance with the EMV (Europay Mastercard Visa) standard used for contactless payments.

However, as indicated above, the smart card according to the invention does not need to establish contactless payments itself. This function can in fact be provided by a mobile device on which the data representative of the card are registered.

It is therefore sufficient for the radio-frequency antenna to be able to establish contactless communication with the mobile device so as to register the data representative of the card, this being perfectly possible with a radio-frequency antenna of small dimensions.

The contour of the upper face of the electronic module may have a rectangular shape with a length of between 8 and 11 mm and a width of between 11 and 13 mm.

Here, “rectangular” is understood to mean a generally rectangular shape, possibly including variations such as rounded corners or slightly curved edges.

The insert may have a cylindrical shape the cross section of which corresponds to the contact surface of the electronic module.

Here, “cylindrical” is understood to mean a generally cylindrical shape, the insert possibly comprising asperities or small hollows at the interface between the various components, without being perfectly cylindrical.

Thus, the dimensions of the radio-frequency antenna cannot exceed those of the contour. At most, the largest turn of the radio-frequency antenna can have dimensions equal to those of the contour.

However, these dimensions, regardless of the technology used, do not allow the radio-frequency antenna to have sufficient communication performance to meet the EMV standards.

For example, the radio-frequency antenna may comprise a larger turn extending in a plane parallel to the external face of the electronic module and having, in said plane, a length of less than or equal to 11 mm and a width of less than or equal to 8 mm.

The cavity may have a cylindrical shape the cross section of which corresponds to its periphery on the first face of the metal layer.

The internal cavity may have a volume V1 representing between 1% and 5% of a volume V2 of the metal layer.

The reduction in weight is therefore imperceptible to a user.

The insert may comprise a substrate, separate from the electronic module and the magnetic shielding layer, carrying the radio-frequency antenna; the electronic module comprising a first connection pad electrically connected, on the one hand, to the microcircuit and, on the other hand, to one end of the radio-frequency antenna so as to electrically interconnect the microcircuit and the radio-frequency antenna.

Alternatively, the electronic module may comprise a support simultaneously carrying the external contacts, the microcircuit and the radio-frequency antenna.

The smart card may be devoid of any other radio-frequency antenna and/or of any other cavity.

The absence of any other radio-frequency antenna and/or of any other cavity maximizes the amount of metal present in the smart card, this contributing to maintaining a relatively heavy weight and a uniform metallic appearance.

The invention is also targeted at, according to a second aspect, an assembly comprising a smart card according to the first aspect of the invention and a mobile device, such as a smartphone, the mobile device comprising a contactless communication module configured to interrogate the radio-frequency antenna of said smart card, receive and process the unique code transmitted by said radio-frequency antenna, and register the data representative of the smart card from the unique code in the mobile device.

It is then possible to establish contactless communications using the mobile device in place of the smart card, which can be used to establish contact-based communications and has a relatively heavy weight and a relatively large visible metallic surface.

Finally, the invention is targeted at, according to a third aspect, use of the assembly according to the second aspect for making payments, wherein the smart card is a bank card configured to make only contact-based payments, and wherein the contactless communication module of the mobile device is configured to make contactless payments in place of the smart card, after having registered the data representative of said card on the mobile device.

In other words, the invention is targeted at a method for making payments using an assembly according to the second aspect, the method comprising at least steps of: making only contact-based payments with the smart card, and
making contactless payments in place of the smart card, after having registered the data representative of said card on the mobile device.

### BRIEF DESCRIPTION OF THE FIGURES

The invention, according to an exemplary embodiment, will be better understood and its advantages will become more clearly apparent on reading the detailed description that follows, which is given by way of completely non-limiting indication, with reference to the appended drawings.

FIG. 1 and FIG. 2 schematically show a metal smart card according to the invention.

FIG. 3 shows, in a schematic sectional view, an insert integrated into the card body of the metal smart card according to the invention.

FIG. 4 schematically shows the insert of FIG. 4 taken in isolation.

FIG. 5 schematically shows an assembly comprising a mobile device and the smart card of FIGS. 1 and 2.

FIG. 6 and FIG. 7 show an insert, taken in isolation, according to a first exemplary embodiment of the invention.

FIG. 8 and FIG. 9 show a substrate of the insert of FIGS. 5 and 6.

FIG. 10 shows an insert, taken in isolation, according to a second exemplary embodiment of the invention.

### DETAILED DESCRIPTION OF THE INVENTION

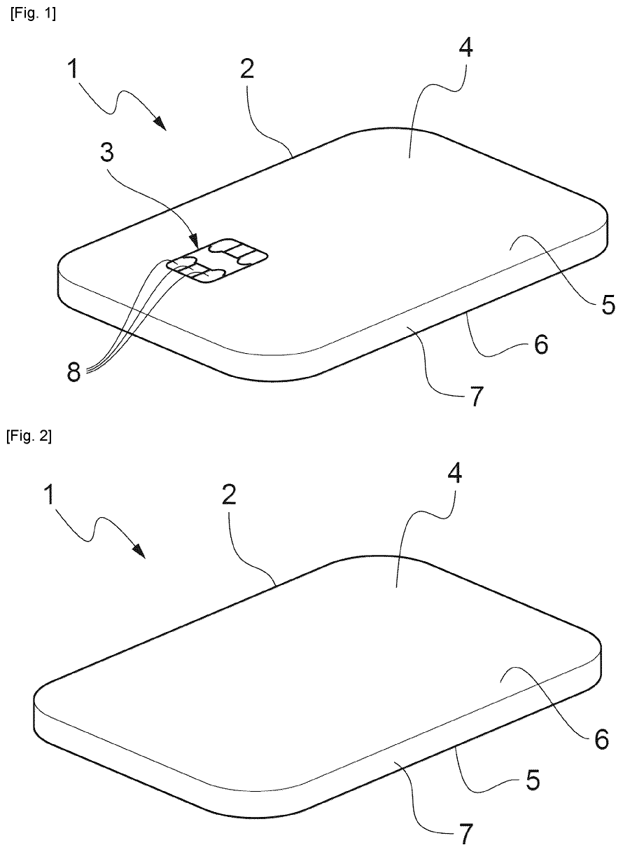

FIGS. 1 and 2 show a metal smart card 1.

The smart card 1 can be used as a bank card, a loyalty card, an access card, etc.

In the present description, the smart card 1 will be described, by way of example, as a bank card configured to make payments.

Depending on the use, the smart card 1 may have several formats. It has, for example, as shown, a rectangular shape the dimensions of which are compliant with the ISO 7810 standard, that is to say that it has a length of 85.60 mm, a width of 53.98 mm and a thickness of 0.76 mm.

The smart card 1 comprises a card body 2 and an electronic module 3 integrated into the card body 2.

The card body 2 comprises a metal layer 4. The presence of this metal layer 4 allows the smart card 1 to be qualified as a metal card.

In the example shown, the metal layer 4 is made of one and the same material, for example stainless steel, silver, gold, copper, titanium or tungsten.

The metal layer 4 has a first face 5, a second face 6 opposite the first face 5, and an edge 7 that joins the peripheries of the first face 5 and of the second face 6 and forms the external contour of the metal layer 4.

The metal layer 4 here has a thickness of about 0.76 mm, the thickness being able to vary by plus or minus 0.08 mm and corresponding to the distance separating the first face 5 from the second face 6 of the metal layer, measured perpendicularly to the first face 5 and/or to the second face 6.

The first face 5 of the metal layer 4 comprises the electronic module 3, while the remaining surface is metallic.

In particular, the electronic module 3 occupies a minority part of the surface of the first face 5 of the metal layer 4, for example less than 5% of the surface of the first face 5, for example about 2%.

The metallic appearance of the first face 5, which is sought after by users of a metal smart card, is therefore predominant here.

Specifically, when a user observes the first face 5, they see the electronic module 3 integrated into the metal layer 4, without a gap or with a very small gap. The user thus has the impression that the metallic surface is fully used up and that there could not be any more metal.

The second face 6 of the metal layer 4 here comprises only one continuous metallic surface, without any other visible element. No component, including the microcircuit 10, appears on the second face 6.

The metallic appearance of the second face 6 is therefore maximal.

The user thus sees that the amount of metal in the card body 2 is maximized. The card body 2 shown gives the impression that only one cavity intended to receive the electronic module 3 has been made and that all the rest of the card body 2 is made of metal.

The electronic module 3 comprises a microcircuit (not visible) and a contact surface 9 comprising external contacts 8, also called contact areas, electrically connected to the microcircuit and flush with the first face 5 so as to allow contact-based communication between the microcircuit and an external terminal.

In the example shown, the card body consists of the metal layer 4.

In an example that is not shown, the card body may comprise a first protective layer partially covering the first face of the metal layer and/or a second protective layer partially covering the second face of the metal layer. The first protective layer may comprise an opening disposed facing the contact surface of the electronic module. The contact surface is substantially flush with an external face of the protective layer. The second protective layer may comprise a magnetic strip.

The microcircuit is in particular configured to store and process data, such as a PIN code, perform security operations, such as verification of the PIN code, and allow communication with an external terminal via the external contacts 8.

The external contacts 8 here are formed by metal zones configured to come into contact with connection pins of an external terminal, such as an electronic payment terminal, and are, for example, compliant with the ISO 7816 standard.

In the example shown, the smart card 1 is configured to establish only contact-based payments, that is to say by way of the external contacts 8, for example in accordance with the EMV standard defined by the EMVCo organization.

In other words, the smart card 1 cannot, by itself, establish contactless payments in accordance with the Contactless EMV standard, also defined by the EMVCo organization.

The function to pay contactlessly can be transferred to a mobile device, such as a smartphone, on which data representative of the smart card 1 are registered.

As stated above, the smart card 1 can be registered on a mobile device using a microcircuit storing a unique code associated with the data representative of the smart card 1, and a radio-frequency antenna electrically connected to the microcircuit and configured to transmit the unique code in response to interrogation from the mobile device.

In the known solutions, the microcircuit and the radio-frequency antenna are integrated into the packaging of the smart card, and are generally discarded with the packaging after the data representative of the smart card have been registered on the mobile device.

These elements then become non-recyclable electronic waste, this posing an environmental problem.

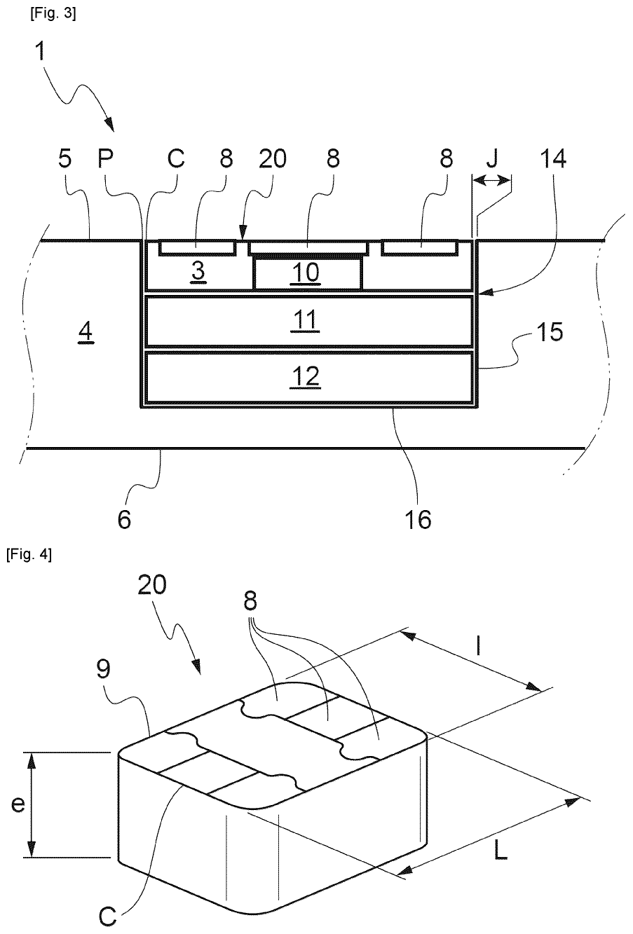

As shown in FIG. 3, the smart card 1 has a radio-frequency antenna 11 integrated directly into the card body 2, and more particularly into the metal layer 4.

The microcircuit 10 is configured, in addition to its initial function mentioned above, to store a unique code associated with the data representative of the smart card 1.

The radio-frequency antenna 11 is electrically connected to the microcircuit 10 of the electronic module 3 so as to allow the unique code to be read by a mobile device.

Thus, advantage is taken of the microcircuit 10 already present in order to allow the smart card 1 to be registered on the mobile device. The amount of material removed from the metal layer 4 is therefore limited, this allowing the smart card 1 to retain a relatively great weight.

To limit the magnetic interference caused by the metal layer 4 and harmful to the operation of the radio-frequency antenna 11, the smart card 1 also comprises a magnetic shielding layer 12.

The magnetic shielding layer 12 is, for example, made of ferrite.

As illustrated in FIG. 3, the metal layer 4 comprises a blind cavity 14 opening out on the first face 5 and defining a periphery P on the first face 5.

The formation of a blind cavity 14 rather than a through cavity disrupts communication with the radio-frequency antenna 11 from the second face 6 but makes it possible to limit the removal of metal from the metal layer 4 and therefore to retain a relatively great weight and metallic appearance.

In particular, the second face 6, which here is devoid of any other cavity, has an entirely metallic surface.

More generally, in the example shown, the metal layer 4 has only one cavity, namely the cavity 14.

The formation of a single cavity in the metal layer 4 makes it possible to maximize the metallic effect and also to maximize the weight of the smart card 1. This also facilitates the manufacture of the smart card and can thus contribute to a reduction in manufacturing costs.

The cavity 14 here has lateral walls 15 and a bottom 16.

In the example shown, the cavity 14 has a cylindrical shape of rectangular cross section, with the lateral walls 15 extending perpendicularly to the first face 5 and the bottom 16 extending parallel to the first face 5.

The electronic module 3, the radio-frequency antenna 11 and the magnetic shielding layer 12 are received in the cavity 14.

As can be seen in FIG. 3, the electronic module 3, the radio-frequency antenna 11 and the magnetic shielding layer 12 are stacked to form an insert 20.

The radio-frequency antenna 11 is disposed between the contact surface 9 of the electronic module 3 and the magnetic shielding layer 12.

The magnetic shielding layer 12 is disposed on the bottom 16 of the cavity 14, while the contact surface 9 is flush with the first face 5 of the metal layer 4.

The contact surface 9 and the magnetic shielding layer 12 constitute end layers of the insert 20.

The electronic module 3, the radio-frequency antenna 11 and the magnetic shielding layer 12 are stacked in a stacking direction, perpendicular to the contact surface 9.

A gap J between the contour C of the contact surface 9 and the periphery P of the cavity 14 on the first face 5 of the metal layer 4 is less than or equal to 0.5 mm.

The radio-frequency antenna 11 and the magnetic shielding layer 12 are then concealed behind the electronic module 3 so that it is not possible to see them from the outside of the smart card 1, as shown in FIG. 1.

FIG. 4 schematically shows the insert 20, taken in isolation.

The insert 20 has a length L and a width l defined by the contour of the contact surface 9. The length L and the width l correspond to the length and to the width of the insert 20 in a plane parallel to the contact surface 9.

If the length L and the width l of the insert 20 are greater than the length and than the width of the contact surface 9 plus the value of the gap J, the insert 20 cannot be received in the cavity 14 without the gap J being greater, at least locally, than said value.

This is explained in particular by the method of mounting the insert 20 in the cavity 14, which consists in pressing the insert 20 into the cavity 14 in a direction orthogonal to the general plane of extension of the metal layer 4.

The insert 20 also has a thickness e, defined in a direction orthogonal to the contact surface 9.

In particular, the insert 20 here has a cylindrical shape of rectangular cross section, with rounded corners.

By way of example, the length L is between 11 mm and 13 mm and the width l is between 8 mm and 11 mm.

The thickness e is between 400 and 600 μm.

A volume V0 of the insert 20 represents at least 75% of a volume V1 of the cavity 14.

The volume V1 of the cavity 14 represents between 1% and 5% of a volume V2 of the metal layer 4.

The removal of metal material from the metal layer 4 is therefore minimized with respect to the volume of the insert 20.

FIG. 5 shows an assembly 100 comprising a smart card 1 and a mobile device 110, which here is a smartphone.

The mobile device 110 is configured to establish contactless communication with the card via the radio-frequency antenna and to make contactless payments, for example in accordance with the ISO/IEC 14443 or ISO/IEC 15693 standard.

In particular, the mobile device 110 comprises a contactless communication module 112, for example an NFC (Near-Field Communication) module.

The radio-frequency antenna has, for example, a resonant frequency of 13.56 MHz, this allowing near-field communication (or NFC) to be established.

If the resonant frequency of the radio-frequency antenna is not equal to 13.56 MHz, a capacitor may be added in order to adjust the resonant frequency for the purpose of achieving this frequency.

The contactless communication module 112 is configured to generate an electromagnetic field in order to register the smart card 1 on the mobile device 110.

By moving the mobile device 110 close to the smart card 1, the electromagnetic field supplies the microcircuit and activates the contactless communication.

The microcircuit of the smart card 1 is configured, in response to a request sent by the contactless communication module 112 of the mobile device 110, to communicate the unique code to the mobile device 110.

Once the mobile device 110 has received the unique code, it is configured to identify the smart card and register it on a payment application.

Once registered, the contactless communication module 112 of the mobile device 110 is configured to make contactless payments by emulating the smart card 1.

Thus, when a user wishes to register the smart card 1 on their mobile device 110, they only need to move the latter close to the smart card 1.

In the smart card 1, the components necessary for registering the representative data on a mobile device 110, namely the microcircuit and the radio-frequency antenna, are directly integrated into the metal layer of the card body.

Thus, when a user wishes to register the data representative of the smart card 1 on a mobile device 110, for example for the purpose of making contactless payments with the mobile device 110 in place of the smart card 1, they only need to move the smart card close to the mobile device.

The microcircuit and the radio-frequency antenna therefore remain in the smart card 1 after the registration. If the smart card 1 is supplied in packaging made of recyclable material, this packaging can be fully recycled since it does not have such electronic components integrated into it.

However, integrating additional components into a metal smart card goes against the practices of designers.

Specifically, a metal smart card is sought after for its heavy weight and its metallic appearance. Any modification that could reduce the mass of metal or alter its appearance is therefore avoided.

The integration of a radio-frequency antenna sized to be able to be used within the scope of EMV transactions, that is to say meeting the communication distance requirements defined by the technical specifications “EMV Level 1 Specifications for Payment Systems-Contactless Interface Specification” and “PayPass-Combination Test”, into the metal layer is all the more avoided by designers since it requires the addition of a magnetic shielding layer to limit magnetic interference. Specifically, this additional layer is likely to further reduce the weight of the metal smart card because this involves reducing the proportion of metal in the card.

The inventors have overcome these biases by integrating such components (a microcircuit, a radio-frequency antenna and a magnetic shielding layer) in a way which limits, or even avoids, the degradation of the metallic appearance and the reduction in weight.

In other words, the inventors have ensured that, visually and in terms of perception of weight, the smart card 1 seems to consist solely of metal, with the exception of the electronic module which remains visible.

On the one hand, the gap between the periphery of the cavity and the contour of the contact surface of the electronic module is chosen so as to conceal the radio-frequency antenna and the magnetic shielding layer behind the contact surface.

Thus, looking at the first face of the smart card 1, only the electronic module filling the cavity is visible. The radio-frequency antenna and the shielding layer are not visible, this allowing the aesthetic appearance of the smart card to be preserved.

On the other hand, the cavity formed in the metal layer is blind, that is to say that it does not pass through the entire thickness of the metal layer. This limits the amount of material removed from the metal layer, and allows the smart card 1 to retain a relatively heavy weight.

The blind cavity also allows the second face to have an entirely metallic surface, this giving a maximum metallic effect to this face.

The blind cavity may, however, prevent the smart card 1 from establishing contactless communication from each of its faces because the metal constitutes an obstacle to radio-frequency transmissions.

Nevertheless, this does not pose any problems of use because the smart card 1 does not need to establish contactless communications (in particular payments) itself. As explained above, this function can be ensured by the mobile device 110 on which data representative of the card 1 are registered.

Consequently, the smart card 1 makes it possible to limit electronic waste after said smart card has been registered on a mobile device 110, all while limiting the degradation of the metallic appearance and the reduction of weight.

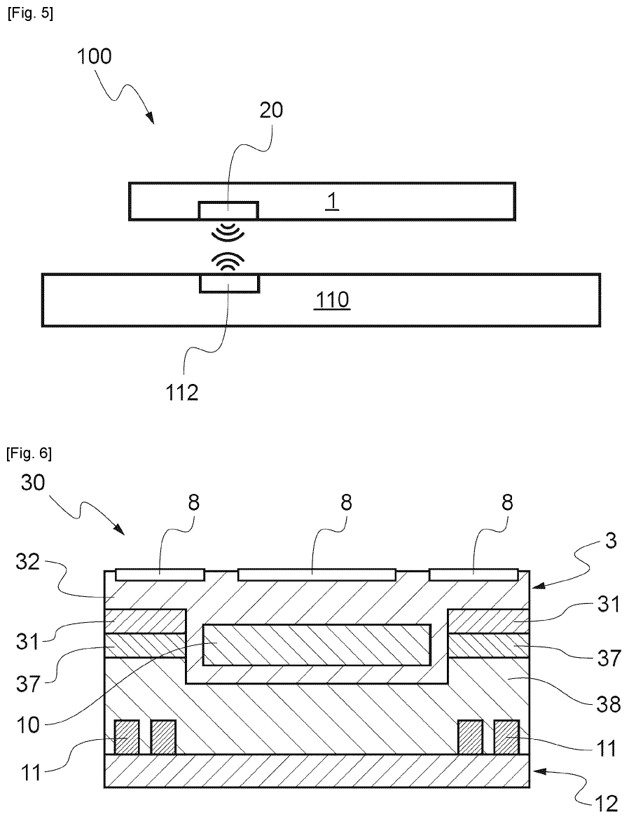

FIGS. 6 and 7 show an insert 30 according to a first exemplary embodiment.

The electronic module 3 here comprises, in addition to the external contacts 8, the microcircuit 10, first connection pads 31 and a support 32.

In the example shown, the support 32 carries the external contacts 8, the microcircuit 10 and the first connection pads 31.

The first connection pads 31 are electrically connected to the microcircuit 10, for example by wires (or tracks).

The support 32 has an external face 33 and an internal face 34 opposite the external face 33.

The microcircuit 10 and the first connection pads 31 are disposed on the internal face 34 of the support 32 while the external contacts 8 are disposed on the external face 33 of the support 32.

In particular, the microcircuit 10 projects from the internal face 34, and in particular with respect to the first connection pads 31.

The insert 30 further comprises second connection pads 37 and a substrate 38.

In the example shown, the substrate 38 carries the radio-frequency antenna 11 and the second connection pads 37.

The substrate 38 here is distinct from the support 32 of the electronic module 3 and from the magnetic shielding layer 12.

The substrate 38 may be attached to the support 32 by means of an electrically conductive adhesive, for example an anisotropic adhesive (often referred to as ACF for “Anisotropic Conductive Film”).

Each second connection pad 37 is electrically connected to a respective end of the radio-frequency antenna 11.

The substrate 38 has an upper face 39, facing towards the electronic module 3, and a lower face 41 opposite the upper face 39.

The radio-frequency antenna 11 is disposed on the side of the lower face 41 of the substrate 38 while the second connection pads 37 are disposed on the upper face 39.

The second connection pads 37 are configured to come into contact with the first connection pads 31, directly or via an electrically conductive adhesive, in order to electrically interconnect the radio-frequency antenna 11 and the microcircuit 10 of the electronic module 3.

The upper face 39 of the substrate 38 has a recessed area 42 configured to at least partially receive the microcircuit 10 of the electronic module 3.

The recessed area 42 is recessed with respect to the second connection pads 37.

The electronic module 3 and the substrate 38 carrying the radio-frequency antenna 11 are configured so that, when the microcircuit 10 is received in the recessed area 42, the first connection pads 31 and the second connection pads 37 are in contact and electrically interconnect the microcircuit 10 and the radio-frequency antenna 11.

The substrate 38 is, for example, attached to the magnetic shielding layer 12 by means of an adhesive.

The magnetic shielding layer 12 may be attached to the metal layer by means of an adhesive.

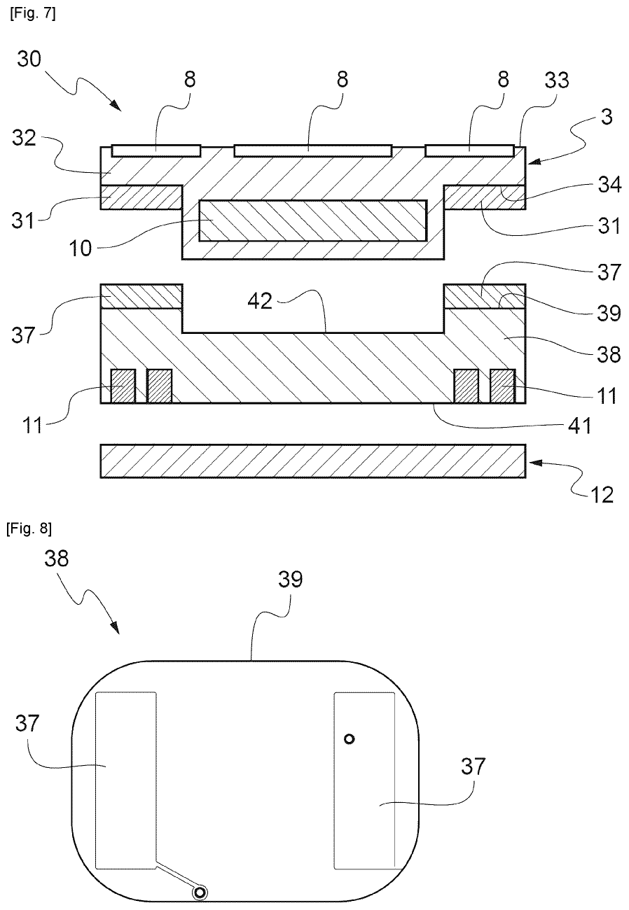

FIGS. 8 and 9 show the upper face 39 and the lower face 41 of the substrate 38, respectively.

The substrate 38 is, for example, made of FR4 (standing for “Flame Retardant 4”), which is a composite of epoxy resin reinforced with glass fibre.

The second connection pads 37, here two in number, are disposed along opposite sides of the upper face 39 of the substrate 38.

Each second connection pad 37 here has a rectangular shape.

The radio-frequency antenna 11 extends along the contour of the lower face 41 of the substrate 38.

The radio-frequency antenna 11 has a winding comprising between 3 and 8 turns.

The radio-frequency antenna 11 has a length L2 of less than or equal to 11 mm and a width l2 of less than or equal to 8 mm.

The radio-frequency antenna 11 has an inter-track distance, that is to say the distance between two successive turns, of between 50 μm and 300 μm.

The radio-frequency antenna 11 is formed by a track having a thickness of 12 μm, 35 μm or 75 μm, the thickness being defined in a direction going from the upper face 39 to the lower face 41 of the substrate 38.

The radio-frequency antenna 11 is, for example, printed directly on the substrate. The substrate 38 then forms, with the radio-frequency antenna 11 and, possibly, the second connection pads 37, a printed circuit board (or PCB).

In particular, the electronic module 3 has a thickness of equal to about 200 μm. The substrate 38 has a thickness of between 150μm and 250 μm. The magnetic shielding layer 12 has a thickness of between 50 μm and 150 82 m.

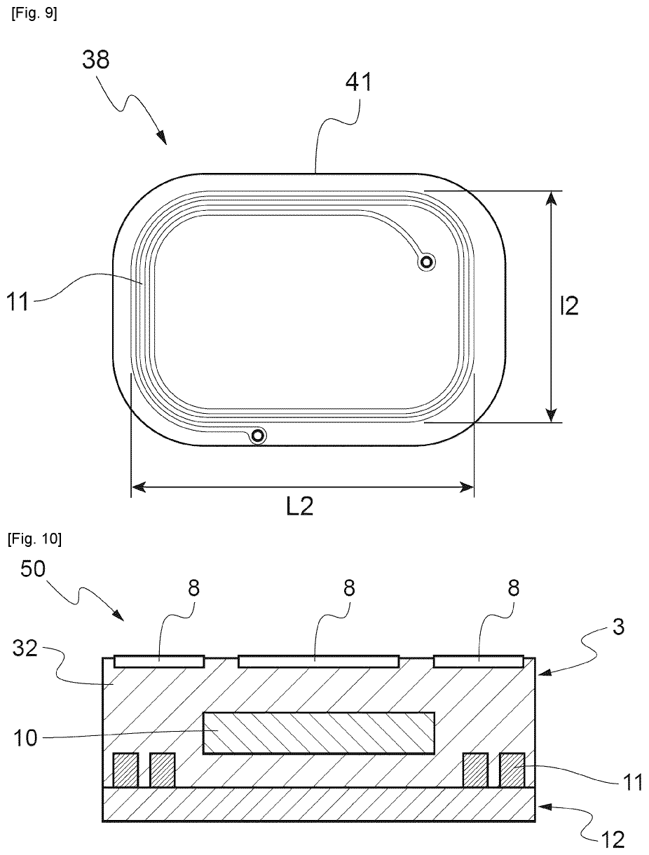

FIG. 10 shows an insert 50 according to a second exemplary embodiment.

The insert 50 differs from the insert illustrated in FIGS. 5 and 6 in that the radio-frequency antenna 11 is carried by the support 32 of the electronic module 3. The electronic module is then devoid of connection pads, the radio-frequency antenna 11 being electrically connected by wires (or tracks) to the microcircuit 10. The insert 50 is also devoid of a substrate.

In particular, the radio-frequency antenna 11 is printed or etched onto the support 32.

The support 32 here therefore simultaneously carries the external contacts 8, the microcircuit 10 and the radio-frequency antenna 11.

The internal face 34 of the support 32 is therefore directly adjacent to the magnetic shielding layer 12.

The radio-frequency antenna 11 is disposed on the internal face 34 of the support 32.

Variants that are not illustrated are presented below.

The card body may consist of the metal layer described.

Materials other than the metal layer may be envisaged.

The card body may comprise a first protective layer covering all or part of the first face of the metal layer and/or a second protective layer covering all or part of the second face of the metal layer.

The card body may consist of the metal layer and of the protective layers.

Each protective layer may be at least partially transparent or at least partially opaque and may be made of plastic or formed of an ink.

The metal layer may be made from an alloy of a number of materials from amongst stainless steel, silver, gold, copper, titanium and tungsten.

The metal layer may be made from a number of materials from amongst stainless steel, silver, gold, copper, titanium and tungsten. Each material may be in the form of a layer, the layers being integrated into each other or superimposed on each other.

The insert and/or the cavity may have a different shape.

The resonant frequency of the radio-frequency antenna may be greater than 13.56 MHz, for example between 13.56 MHz and 20 MHz.

The connection pads may have a different shape, for example circular, or rectangular with rounded corners.

More generally, the invention is not limited to the examples described and shown.

1. A smart card comprising:
a card body; and
an insert,
the card body comprising a metal layer having a first face, a second face opposite the first face, and a blind cavity open on the first face and defining a periphery on said first face,
the insert being inserted into the cavity and comprising
an electronic module having an external face flush with the first face of the metal layer and comprising:
a contact surface disposed on the external face and configured to allow contact-based communication with an external terminal, the external contact surface having a contour of which a gap with the periphery of the cavity on the first face of the metal layer is less than or equal to 0.5 mm, and
a microcircuit configured to register a unique code associated with data representative of the smart card,
a magnetic shielding layer, and
a radio-frequency antenna electrically connected to the microcircuit and disposed between the contact surface of the electronic module and the magnetic shielding layer.

2. The smart card according to claim 1, wherein the microcircuit is electrically connected to the external contacts to allow contact-based communication between the microcircuit and an external terminal.

3. The smart card according to claim 1, wherein a volume of the insert represents at least 75% of a volume of the cavity.

4. The smart card according to claim 1, wherein the insert has a length and a width which are defined by the contour of the contact surface of the electronic module, the length and the width corresponding to the length and to the width of the insert in a plane parallel to the contact surface of the electronic module.

5. The smart card according to claim 1, wherein the contour of the contact surface of the electronic module has a generally rectangular shape with a length of between 8 and 11 mm and a width of between 11 and 13 mm.

6. The smart card according to claim 1, wherein the radio-frequency antenna comprises a larger turn extending in a plane parallel to the external face of the electronic module and having, in said plane, a length of less than or equal to 11 mm and a width of less than or equal to 8 mm.

7. The smart card according to claim 1, wherein the cavity has a volume V1 representing between 1% and 5% of a volume V2 of the metal layer.

8. The smart card according to claim 1, wherein the smart card is devoid of any other radio-frequency antenna and/or of any other cavity.

9. An assembly comprising:
the smart card according to claim 1; and
a mobile device comprising a contactless communication module configured to interrogate the radio-frequency antenna of said smart card, receive and process the unique code transmitted by said radio-frequency antenna, and register the data representative of the smart card from the unique code in the mobile device.

10. The assembly of claim 9, wherein the smart card is a bank card configured to make only contact-based payments, and wherein the contactless communication module of the mobile device is configured to make contactless payments in place of the smart card, after having registered the data representative of said card.

11. The smart card according to claim 2, wherein a volume of the insert represents at least 75% of a volume of the cavity.

12. The smart card according to claim 2, wherein the insert has a length and a width which are defined by the contour of the contact surface of the electronic module, the length and the width corresponding to the length and to the width of the insert in a plane parallel to the contact surface of the electronic module.

13. The smart card according to claim 3, wherein the insert has a length and a width which are defined by the contour of the contact surface of the electronic module, the length and the width corresponding to the length and to the width of the insert in a plane parallel to the contact surface of the electronic module.

14. The smart card according to claim 2, wherein the contour of the contact surface of the electronic module has a generally rectangular shape with a length of between 8 and 11 mm and a width of between 11 and 13 mm.

15. The smart card according to claim 3, wherein the contour of the contact surface of the electronic module has a generally rectangular shape with a length of between 8 and 11 mm and a width of between 11 and 13 mm.

16. The smart card according to claim 4, wherein the contour of the contact surface of the electronic module has a generally rectangular shape with a length of between 8 and 11 mm and a width of between 11 and 13 mm.

17. The smart card according to claim 2, wherein the radio-frequency antenna comprises a larger turn extending in a plane parallel to the external face of the electronic module and having, in said plane, a length of less than or equal to 11 mm and a width of less than or equal to 8 mm.

18. The smart card according to claim 3, wherein the radio-frequency antenna comprises a larger turn extending in a plane parallel to the external face of the electronic module and having, in said plane, a length of less than or equal to 11 mm and a width of less than or equal to 8 mm.

19. The smart card according to claim 4, wherein the radio-frequency antenna comprises a larger turn extending in a plane parallel to the external face of the electronic module and having, in said plane, a length of less than or equal to 11 mm and a width of less than or equal to 8 mm.

20. The smart card according to claim 5, wherein the radio-frequency antenna comprises a larger turn extending in a plane parallel to the external face of the electronic module and having, in said plane, a length of less than or equal to 11 mm and a width of less than or equal to 8 mm.
